(19) United States
(12) Patent Application Publication
(10) Pub. No.: US 2020/0128215 A1
(43) Pub. Date: Apr. 23, 2020

(54) HITCH ASSIST BACKUP CAMERA SYSTEM

(71) Applicant: Panasonic Automotive Systems Company of America, Division of Panasonic Corporation of North America, Peachtree City, GA (US)

(72) Inventor: KEITH WRISLEY, FENTON, MI (US)

(73) Assignee: Panasonic Automotive Systems Company of America, Division of Panasonic Corporation of North America

(21) Appl. No.: 16/599,544

(22) Filed: Oct. 11, 2019

Related U.S. Application Data
(60) Provisional application No. 62/749,340, filed on Oct. 23, 2018.

(51) Int. Cl. H04N 7/18; G06T 5/00; B60R 1/00

(52) U.S. Cl. CPC H04N 7/183; G06T 5/001; B60R 2300/307; B60R 2300/808; B60R 2300/205; B60R 1/00

(57) ABSTRACT

A backup camera system for a motor vehicle includes a rear-view camera capturing images of a scene behind the motor vehicle. An electronic image processor is communicatively coupled to the rear view camera and is operable in a normal mode and in a hitch assist backup mode. When in the hitch assist backup mode, the electronic image processor removes distortion to a greater degree in a first portion of the images than in a second portion of the images. The first portion of the images includes physical elements that are farther away from the camera than are physical elements in the second portion of the images. A video presentation device presents the images to a human driver of the motor vehicle after the images have been processed by the electronic image processor.

### CROSS-REFERENCED TO RELATED APPLICATIONS

This application claims benefit of U.S. Provisional Application No. 62/749,340 filed on Oct. 23, 2018, the disclosure of which is hereby incorporated by reference in its entirety for all purposes.

### FIELD OF THE INVENTION

The disclosure relates to a system to assist in hitching a trailer to the rear of a motor vehicle.

### BACKGROUND OF THE INVENTION

Currently, image distortion correction is focused on having the rear bumper appear normal to the driver. As a result, images beyond the rear bumper appear distorted. The farther away from the rear bumper, the more distortion there is.

The rearview backup camera is used to assist the driver when backing up. The image of the rear bumper is used as a reference for image distortion correction and “fish eye” removal. However, the image of an object beyond the rear bumper is skewed. This means, for example, a trailer hitch coupler when installed appears distorted on the driver information display (e.g., in-vehicle infotainment (IVI), instrument cluster, head up display (HUD), rear view mirror), and this makes it difficult to align the trailer ball with a trailer.

### SUMMARY

In one embodiment, the present invention may use an image processing (e,g,, pixel mapping) algorithm and digital zoom inside the backup camera or external processing (e.g., IVI, cockpit domain controller or other electronic modules) when coupling a trailer to the vehicle. The hitch assist system of the present invention can switch to an image processing mode that is designed to reduce trailer hitch coupler distortion and provide a close-up view (e.g., make the trailer hitch coupler look normal). Driver warning messages to set the parking brake and place the vehicle in the park gear can be added to the driver information display. Additionally, as high-resolution automotive cameras become mainstream, the digital zoom capability of the present invention may further enhance the image quality for the hitch assist system.

In one embodiment, the invention comprises a backup camera system for a motor vehicle, including a rear-view camera capturing images of a scene behind the motor vehicle. An electronic image processor is communicatively coupled to the rear-view camera and is operable in a normal mode and in a hitch assist backup mode. When in the hitch assist backup mode, the electronic image processor removes distortion to a greater degree in a first portion of the images than in a second portion of the images. The first portion of the images includes physical elements that are farther away from the camera than are physical elements in the second portion of the images. A video presentation device presents the images to a human driver of the motor vehicle after the images have been processed by the electronic image processor.

In another embodiment, the invention comprises a method of operating a backup camera system for a motor vehicle. The method includes capturing images of a scene behind the motor vehicle. Operation of an electronic image processor is switched between a normal mode and a hitch assist backup mode. In the hitch assist backup mode, the electronic image processor removes distortion to a greater degree in a first portion of the images than in a second portion of the images. The first portion of the images includes physical elements that are farther away from the motor vehicle than are physical elements in the second portion of the images. The images are presented to a human driver of the motor vehicle after the images have been processed by the electronic image processor while operating in the hitch assist backup mode.

In yet another embodiment, the invention comprises a backup camera system for a motor vehicle. The system includes a rear-view camera positioned and configured to capture images of a scene behind the motor vehicle. Sensing means detects a presence of a trailer coupler behind the motor vehicle. An electronic image processor is communicatively coupled to the rear view camera and to the sensing means. The electronic image processor is operable in a normal mode and in a hitch assist backup mode. The electronic image processor switches its operation from the normal mode to the hitch assist backup mode in response to the sensing means detecting the presence of the trailer coupler behind the motor vehicle. When in the hitch assist backup mode, the electronic image processor removes distortion to a greater degree in a first portion of the images than in a second portion of the images. The first portion of the images includes physical elements that are farther away from the camera than are physical elements in the second portion of the images. A video presentation device is communicatively coupled to the electronic image processor and presents the images to a human driver of the motor vehicle after the images have been processed by the electronic image processor.

An advantage of the present invention is that the trailer hitch coupler appears normal on the driver information display. This enables the driver to easily align the trailer ball with the trailer.

### BRIEF DESCRIPTION OF THE DRAWINGS

A better understanding of the present invention will be had upon reference to the following description in conjunction with the accompanying drawings.

FIG. 1 is a block diagram of one example embodiment of a hitch assist backup camera system of the present invention for a motor vehicle,

FIG. 2 is a flow chart of one example embodiment of an image processing algorithm of the present invention for use in conjunction with the hitch assist backup camera system of FIG. 1. FIG. 3 is a flow chart of one example embodiment of a method of the present invention for operating a backup camera system in a motor vehicle.

### DETAILED DESCRIPTION OF THE PREFERRED EMBODIMENTS

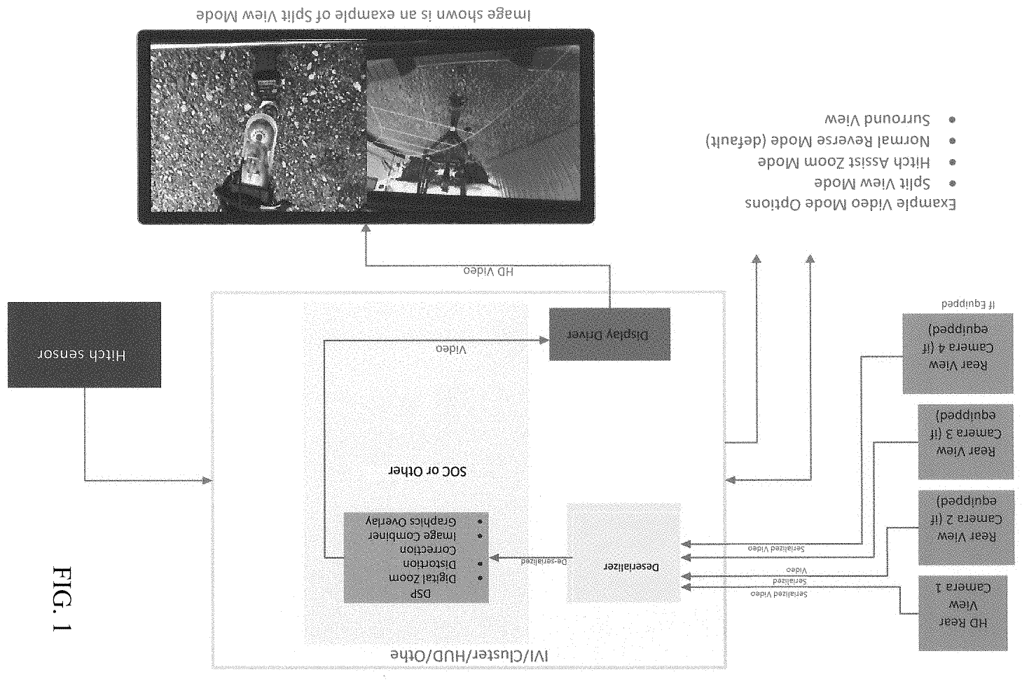

FIG. 1 illustrates one example embodiment of a hitch assist backup camera system of the present invention for a motor vehicle. The hitch assist backup camera system includes a driver information display (e.g., in-vehicle infotainment (IVI), instrument cluster, head up display (HUD), rear view mirror) having a deserializer, a digital signal processor (DSP) which may be a system-on-chip (SoC), and a display driver. The DSP may enable digital zoom, distortion correction, image combiner, and graphics overlay.

The deserializer may receive serialized video inputs from a high definition (HD) rear view camera as well as from a number of other rear-view cameras. Three such other rear-view cameras are shown in FIG. 1.

The driver information display also receives inputs from a hitch sensor. The display driver of the driver information display transmits an HD video signal to a video presentation device, which may include a display screen or a HUD, for example,

The video presentation device is shown in FIG. 1 in a split screen mode wherein on a left-hand side of the screen there is presented a zoomed out view wherein the trailer frame is visible and distortions created by a fish-eye lens have been removed via video processing such that the image is very similar to what may be seen with the naked eye without the benefit of a camera. On a right-hand side of the screen there is presented a zoomed in view of the ball mount and coupler wherein the trailer frame is mostly out of view. Here too, distortions created by a fish-eye lens have been removed via video processing such that the image is very similar to what may be seen with the naked eye without the benefit of a camera.

Although the video presentation device is shown in FIG. 1 in a split screen mode, it is also possible for the video presentation device to operate in a hitch assist zoom mode, a normal reverse mode (which the system may be in by default), or a surround view mode.

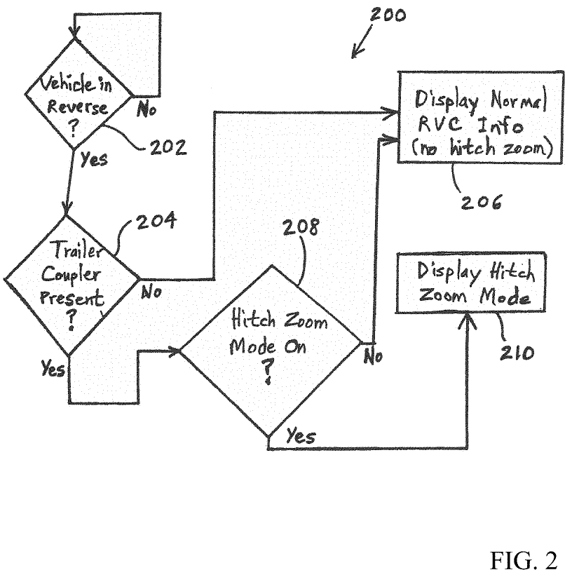

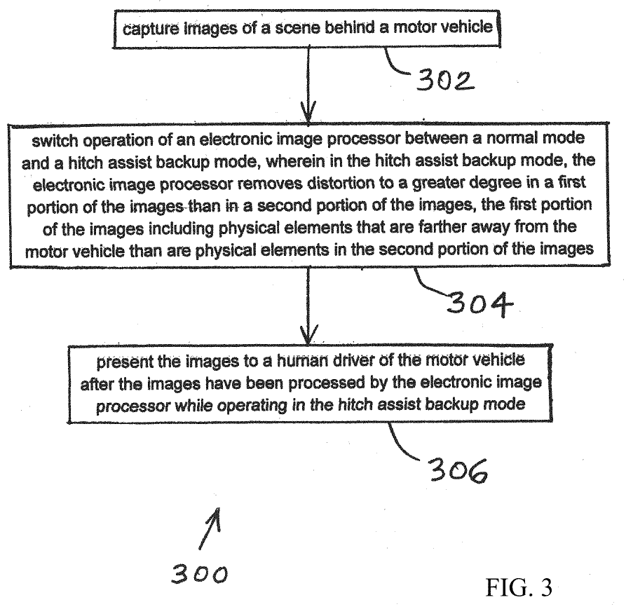

FIG. 2 illustrates one example embodiment of an image processing algorithm 200 of the present invention for use in conjunction with the hitch assist backup camera system of FIG. 1 as used in a motor vehicle. In a first step 202, it is determined whether the motor vehicle is in a reverse gear. If not, then no further steps are taken until it is determined that the motor vehicle is in a reverse gear, in which case operation proceeds to step 204 wherein it is determined whether a trailer coupler is present behind the motor vehicle. The determination in step 204 may be made by an electronic processor analyzing the signals received from the hitch sensor, which may be a radar- or lidar-based device that detects a presence of an object approximately between one and five feet behind the vehicle. The determination in step 204 may also be made by an electronic processor analyzing the images captured by the HD rear view camera and ascertaining therefrom whether a trailer hitch coupler and/or trailer is disposed behind the vehicle at distance of approximately between one and ten feet behind the vehicle.

If it is determined in step 204 that the trailer coupler is not present, then operation proceeds to step 206 where the video presentation device displays normal rear-view camera (RVC) information without any hitch zoom. For example, the video presentation device may display unaltered images captured by the HD rear view camera.

If, however, it is determined in step 204 that the trailer coupler is present, then operation proceeds to step 208 where it is determined whether the hitch zoom mode is on. The determination in step 208 may be made on the basis of the position of a switch that the user may toggle between an ON position and an OFF position. The determination in step 208 may also be made on the basis of user inputs via voice, pushbuttons, or a touch screen, for example.

If it is determined in step 208 that the hitch zoom mode is not on (i,e., is off), then operation proceeds to step 206. If, however, it is determined in step 208 that the hitch zoom mode is on, then operation proceeds to step 210 where the driver information display operates in the hitch zoom mode. For example, the video presentation device may display a zoomed in view of the trailer ball and coupler with any distortion from the fisheye lens being removed via image processing. Thus, when in this hitch zoom mode, the entire video presentation device may display an image similar to what is shown on the right-hand side of the presented image in FIG. 1. FIG. 3 illustrates one example embodiment of a method 300 of the present invention for operating a backup camera system in a motor vehicle. In a first step 302, images of a scene behind the motor vehicle are captured. For example, one of the rear view cameras shown in FIG. 1 may capture images of a scene behind a motor vehicle.

In a next step 304, operation of an electronic image processor is switched between a normal mode and a hitch assist backup mode. In the hitch assist backup mode, the electronic image processor removes distortion to a greater degree in a first portion of the images than in a second portion of the images. The first portion of the images includes physical elements that are farther away from the motor vehicle than are physical elements in the second portion of the images. For example, a switch that the user may toggle between an ON position and an OFF position may he used to turn a hitch zoom mode ON and OFF. In the hitch zoom mode, the DSP in FIG. 1 may remove distortion more from scenery that is relatively far away from the camera (e.g., a trailer) than from scenery that is relatively close to the camera (e.g., the trailer hitch coupler).

In a final step 306, the images are presented to a human driver of the motor vehicle after the images have been processed by the electronic image processor while operating in the hitch assist backup mode. For example, after the DSP has removed distortion from the images captured by the camera, the images may be presented to the human driver on the display screen shown in FIG. 1.

The foregoing description may refer to “motor vehicle”, “automobile”, “automotive”, or similar expressions. It is to be understood that these terms are not intended to limit the invention to any particular type of transportation vehicle. Rather, the invention may he applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A backup camera system for a motor vehicle, the system comprising:
a rear-view camera positioned and configured to capture images of a scene behind the motor vehicle;
means for sensing a presence of a trailer hitch;
an electronic image processor communicatively coupled to the rear view camera and to the sensing means, the electronic image processor being selectively operable in a normal mode and in a hitch assist backup mode dependent upon signals received from the sensing means, when in the hitch assist backup mode, the electronic image processor being configured to remove distortion to a greater degree in a first portion of the images than in a second portion of the images, the first portion of the images including physical elements that are farther away from the camera than are physical elements in the second portion of the images; and
a video presentation device communicatively coupled to the electronic image processor and configured to present the images to a human driver of the motor vehicle after the images have been processed by the electronic image processor.

2. The system of claim 1 wherein the camera includes a fish-eye lens.

3. The system of claim 1 wherein when in the normal mode, the electronic image processor does not remove distortion from the images.

4. The system of claim 1 wherein the first portion of the images is above the second portion of the images.

5. The system of claim 1 wherein the physical elements of the first portion of the images include a trailer.

6. The system of claim 5 wherein the physical elements of the second portion of the images include a trailer hitch coupler.

7. The system of claim 1 wherein the video presentation device comprises a display screen or a head up display.

8. A method of operating a backup camera system for a motor vehicle, the method comprising:
capturing images of a scene behind the motor vehicle;
switching operation of an electronic image processor between a normal mode and a hitch assist backup mode, wherein in the hitch assist backup mode, the electronic image processor removes distortion to a greater degree in a first portion of the images than in a second portion of the images, the first portion of the images including physical elements that are farther away from the motor vehicle than are physical elements in the second portion of the images; and
presenting the images to a human driver of the motor vehicle after the images have been processed by the electronic image processor while operating in the hitch assist backup mode.

9. The method of claim 8 wherein the images are captured by a camera having a fish-eye lens.

10. The method of claim 8 wherein when in the normal mode, the electronic image processor does not remove distortion from the images.

11. The method of claim 8 wherein the first portion of the images is above the second portion of the images.

12. The method of claim 8 wherein the physical elements of the first portion of the images include a trailer.

13. The method of claim 12 wherein the physical elements of the second portion of the images include a trailer hitch coupler.

14. The method of claim 8 wherein the images are presented on a display screen or a head up display.

15. A backup camera system for a motor vehicle, the system comprising:
a rear-view camera positioned and configured to capture images of a scene behind the motor vehicle;
means for sensing a presence of a trailer coupler behind the motor vehicle;
an electronic image processor communicatively coupled to the rear view camera and to the sensing means, the electronic image processor being operable in a normal mode and in a hitch assist backup mode, the electronic image processor being configured to switch its operation to the hitch assist backup mode in response to the sensing means detecting the presence of the trailer coupler behind the motor vehicle, wherein, when in the hitch assist backup mode, the electronic image processor is configured to remove distortion to a greater degree in a first portion of the images than in a second portion of the images, the first portion of the images including physical elements that are farther away from the camera than are physical elements in the second portion of the images; and
a video presentation device communicatively coupled to the electronic image processor and configured to present the images to a human driver of the motor vehicle after the images have been processed by the electronic image processor.

16. The system of claim 15 wherein the camera includes a fish-eye lens.

17. The system of claim 15 wherein when in the normal mode, the electronic image processor does not remove distortion from the images.

18. The system of claim 15 wherein the first portion of the images is above the second portion of the images.

19. The system of claim 15 wherein the physical elements of the first portion of the images include a trailer.

20. The system of claim 19 wherein the physical elements of the second portion of the images include a trailer hitch coupler.

21. The system of claim 15 wherein the video presentation device comprises a display screen or a bead up display.

22. The system of claim 15 wherein the sensing means comprises a hitch sensor.

23. The system of claim 22 wherein the hitch sensor comprises a radar-based device or a lidar-based device.

24. The system of claim 15 wherein the sensing means comprises an electronic processor analyzing images captured by the camera.
